(19) United States
(12) Patent Application Publication
(10) Pub. No.: US 2014/0356111 A1
(43) Pub. Date: Dec. 4, 2014

(54) METHOD OF HANDLING OBJECTS IN AN AIRPORT AND HANDLING SYSTEM

(71) Applicants: Uffe Lykkegaard, Aarhus C (DK); Lasse Lund Jensen, Skodstrup (DK)

(72) Inventors: Uffe Lykkegaard, Aarhus C (DK); Lasse Lund Jensen, Skodstrup (DK)

(73) Assignee: CRISPLANT A/S, Aarhus N (DK)

(21) Appl. No.: 14/345,589

(22) PCT Filed: Aug. 27, 2012
(86) PCT No.: PCT/DK2012/050309

§ 371 Date: Mar. 18, 2014

(30) Foreign Application Priority Data
Sep. 22, 2011 (DK) PA 2011 70522

(51) Int. Cl. B65G 67/04; B64F 1/36

(52) U.S. Cl. CPC B65G 67/04; B64F 1/368
USPC 414/398; 414/809

(57) ABSTRACT

An example of an aim with the disclosed method and system may be seen to provide a method and system which does not require more square meters of footprint than existing solutions or even requires less square meters of footprint, while still being as effective as, or even more effective than reference methods and systems. The handling system comprises a moveable unit 101 adapted to move linearly in a travelling direction 406 of said moveable unit, where the moveable unit comprises a loading device 100 adapted to load one or more objects 102 at a time into or onto the airport trolley by activation of the loading device 100.

### FIELD OF THE INVENTION

The invention relates to material handling in an airport. In particular, the invention relates to loading of luggage into a moveable storage using a loading device, which moveable storage is to be used for moving a plurality of luggage pieces from a material handling area and/or sorting area and to an aeroplane.

### BACKGROUND OF THE INVENTION

After having checked in a piece of luggage, i.e. an object, in an airport, such piece of luggage or object is typically handled by a number of conveyors and/or sorters. Such equipment is provided for moving the object and/or sorting the object in order for the object to reach its destination.

Even in small airports, quite large numbers of objects are handled.

When handling such numbers of objects one or more of the following factors is/are typically of paramount importance: that the object is handled as fast as possible, as safely as possible, as effectively as possible, in a process and with technology which is as reliable as possible, and with technology which requires a minimum of or even no maintenance.

Still further, the equipment must typically be installed at a minimum of floor surface, i.e. square meters of footprint, among others and as an example in order to fit existing buildings or in order not to create extensive cost of buildings for the equipment.

In order to provide methods and equipment which offer as many of such or other factors as possible, various solutions have been proposed.

EP2102063 discloses a method and system in which handling of objects in an airport includes using paternoster belts.

The system and method disclosed in EP2102063 may be found to result in one or more disadvantages when considering one or more of the mentioned factors or other factors, which factors are important to a supplier of technology which for many years and as an example, most prove effective.

In consequence, the present invention is provided and it has been appreciated that an improved method of handling a variety of objects of different size, shape and weight in an airport and a handling system adapted to carry out the method is of benefit.

### SUMMARY OF THE INVENTION

It may be seen as an object of the present invention to provide an improved method of handling a variety of objects of different size, shape and weight in an airport and an improved handling system adapted to carry out the method.

Preferably, the invention alleviates, mitigates or eliminates one or more of the above or other disadvantages singly or in any combination.

Alternatively or additionally, it may be seen as an object of the invention to provide a method of handling a variety of objects of different size, shape and weight in an airport and an improved handling system adapted to carry out the method, which method and system has an improved effectiveness when compared to one or more reference methods and systems.

Possibly in particular, it may be seen as an object of the invention to provide a method and system, which method and system does not require more square meters of footprint than existing solutions, or even requires less square meters of footprint, while still being as effective as or even more effective than reference methods and systems and/or e.g. able to obtain a same or better filling degree of each moveable storage.

Accordingly there is provided, in a method aspect of the invention, a method of handling a variety of objects of different size, shape and weight in an airport, the method comprising
determining a destination for an object using scanning equipment, such as a barcode scanner,
moving the object in accordance with the destination using conveyors and/or one or more sorters,
loading the object into or onto a moveable storage device using a loading device, where said storage device is to be used for moving a plurality of objects to an aeroplane for the destination, and wherein said moveable storage device is an airport trolley.

Thus, an improved method of handling a variety of objects of different size, shape and weight in an airport is provided. Each object is a piece of luggage or a piece of luggage placed in a tote or other container for improved handling of that piece of luggage. An improvement or advantage of the method may be seen to lie therein that when handling the objects as described, a method which is more effective than reference systems is provided. A particular advantage may be seen to be that for the method described herein existing airport trolleys are used and filled with the objects.

Various attempts, such as a cart disclosed in EP2057063 which comprises an inner space partly occupied by layers of declining rollers and where gravity is used in order to distribute objects in the cart, have been made to provide special trolleys with the aim in this way to increase the effectiveness of the manner in which the objects can be handled, and such as to increase a number of objects capable of being loaded into or onto a given trolley.

When the airport trolley is of a type which has a bottom and a number of sides, which sides extend upwards from the bottom and surround the bottom, which bottom and sides, when no objects are present in the airport trolley, form an empty space without hindrances, which space can be filled with objects, to form a bulk of objects in the airport trolley, a standard airport trolley of the type already present in most airports is used. Preferably, the length of the airport trolley is larger than an airport trolley width. Thus, the airport trolley is normally and preferably somewhat elongated, where an airport trolley length is longer than an airport trolley width.

At least for embodiments of the present invention, it is preferred that the trolley is the standard airport trolley as described and shown herein. Some airport trolleys which are also found to fall within the definition of a standard airport trolley are used in some particular airports. These airport trolleys additionally comprise a longitudinal extending member placed somewhat above the empty space. The member is used for enabling protective curtains or the like to protect objects in the trolley against outside weather conditions, for safety, and/or to prevent objects from falling off the trolley.

When preparing for loading the object into or onto the airport trolley comprises moving the object parallel with or substantially parallel with the trolley length, a possible advantage is that such method and resulting layout and footprint of a system for such method is of benefit when considering a number of square meters required to carry out handling of the objects. Still further, such method can be found to increase a filling degree of objects in the airport trolley.

The airport trolley comprises wheels as illustrated in the drawings. A straight forward or straight backward rolling direction of the airport trolley, when the airport trolley is moved in the rolling direction of the wheels, is along the length of the airport trolley. Thus, when preparing for loading the object 102 into or onto the airport trolley, i.e. prior to loading the object into or onto the airport trolley, comprises moving the loading device along or substantially along such straight forward or straight backwards rolling direction of the airport trolley, a particular advantage is that a particularly space-saving solution and handling method is provided.

When preparing for loading the object into or onto the airport trolley comprises moving the object on the loading device by using a moveable unit adapted to move the loading device linearly in a travelling direction of the moveable unit, a possible advantage may be seen to be that such method and corresponding system is particularly simple to install and/or to control and/or to maintain and thus increases overall effectiveness of the method and corresponding system.

Similarly, when moving the object parallel with or substantially parallel with an airport trolley length of the airport trolley, or moreover parallel with or substantially parallel with a direction of said airport trolley length as shown in the drawing at the reference number 106, is carried out at one vertical level of and by the moveable unit, a possible advantage may be seen to be that such method and corresponding system is particularly simple to install and/or to control and/or to maintain and thus increases overall effectiveness of the method and corresponding system. Alternatively, the moveable unit may be adapted to be slightly adjustable in its vertical level, such as to be able to move in 2 or 3 different levels of height and load one or more objects into an airport trolley from such levels. Alternatively the unit is moveable at one single level and a level of the loading device is slightly adjusted prior to loading the object into the airport trolley at such adjusted level.

When the method further comprises buffering one or more objects prior to the objects being handled by the loading device, where the buffering is provided using a buffer having a buffer length and a buffer width and where the buffer length is larger than the buffer width, and a moving direction of objects in the buffer is in a buffer length direction and the buffer length direction is parallel with or substantially parallel with the airport trolley length, a possible advantage is that such method and resulting layout and footprint of a system for such method is of benefit when considering a number of square meters required to carry out handling of the objects.

When buffering comprises the buffered objects being buffered and possibly moved in the moving direction at one vertical buffer level or substantially at one vertical buffer level along and in the buffer, a possible advantage is, that, a method fully capable of providing a filling degree of objects in the airport trolleys as good as or even better than in reference systems is obtained, but by using a far simpler method and equipment.

When the vertical level of the moveable unit is the same or substantially the same as the vertical level of the buffer, and moving the objects along and in the buffer and moving the objects by the moveable unit is provided by moving the objects at the same vertical level or substantially at the same vertical level, a method and corresponding system is provided for which a particularly low amount of maintenance is foreseen.

A particularly simple and easy maintainable and controllable system and method may be provided when the same vertical level or the substantially same vertical level is adapted for loading an object into or onto the airport trolley by the loading device from a vertical level at, or just above, a loading edge of the airport trolley.

When the loading device has a loading direction which is transverse to or substantially transverse to the airport trolley length and the method includes actuating the loading device in that loading direction and hereby loading the object into or onto the trolley, a method for which the required footprint for carrying out the loading is particularly decreased while the simplicity of the method and system and the filling degree of the airport trolley is increased, is provided.

When an end most conveyor of the buffer has a conveying direction which is substantially parallel with or parallel with the loading direction of the loading device and transfer of objects from the end most conveyor to the loading device is provided in this direction, a particularly effective, reliable, space-saving, repeatable and/or robust manner of handling the objects is obtained.

In accordance with an embodiment of the invention, loading the object into or onto the airport trolley is provided while the trolley is at rest. In particular, the method and corresponding system is particularly effective when two airport trolleys are coupled in line and in tandem in fixed relative position to each other and at rest, and when loading is carried out into or onto one of such airport trolleys.

When positioning one or two airport trolleys with their length direction parallel with or substantially parallel with the travelling direction of the moveable unit, a particularly effective manner of loading the objects into or onto the airport trolleys is provided.

When setting a number of predetermined positions along the travelling direction of the moveable unit and moving the moveable unit linearly in the travelling direction to one of the predetermined number of loading positions along one, two or more airport trolleys, a method enabling a high filling degree of the one, two or more airport trolleys is provided.

In accordance with a particular embodiment of the invention, handling the objects comprises
discharging the object from a sorting or a conveyor system,
after discharging the object: moving the object in a first transfer direction, such as a moving direction of the object in a buffer,
after having moved the object in the first transfer direction: changing moving direction of the object and so as hereafter to enable moving the object in a second transfer direction, such as a conveying direction of an end most conveyor of the buffer,
transferring the object along the second direction to the loading device and either:
   a) moving the loading device in a third direction, such as in a travelling direction of a moveable unit, and subsequently loading the object into or onto a first or a second airport trolley by activating the loading device, or
   b) maintaining a position of the loading device and loading the object into or onto a first airport trolley by activating the loading device at said position, where an election between a) or b) is provided in dependence of a number and/or position of objects in or on the first and/or the second airport trolley and/or in dependence of a number and/or position of one or more objects prior to the loading device, which one or more objects are to be loaded.

An advantage of such embodiment may be seen to be that hereby effectiveness of the handling system is increased, and when combined with a method and corresponding system where the second transfer direction is transverse or substantially transverse to the first transfer direction, the effectiveness of the handling method has been found to be increased even further.

Similarly, when the first and third directions are parallel or substantially parallel and/or a vertical level of the moving objects is the same or substantially the same in two or more vertical levels of movement among the first, second and third transfer directions, a possible advantage is that a particularly reliable, simple and easy automated handling of the objects is provided for which a corresponding system is e.g. also effective and/or reliable and/or easy maintainable and/or requires low maintenance.

Surprisingly, it has also been found that when moving an object in the third transfer direction comprises moving the object in a direction opposite to or substantially opposite to the first transfer direction, a handling method which is particularly effective, despite the additional travel length of an object, is provided.

In accordance with an apparatus aspect of the invention, there is provided a handling system adapted to carry out the method as described herein. The handling system includes a moveable unit adapted to move linearly in a travelling direction of the moveable unit, the moveable unit comprising at least one loading device, such as two separate moveable units, each moveable unit being adapted to load one or more objects at a time into or onto an airport trolley having an airport trolley length, by activation of the loading device.

In accordance with embodiments of the invention, the moveable unit is adapted to move in the traveling direction at one maintained vertical level and/or the handling system also includes a buffer for buffering one or more objects prior to the loading device, and where two or more of: a length of the buffer, a travelling direction of the moveable unit and the length of the airport trolley are parallel or substantially parallel.

In accordance with further embodiments, two or more of: a vertical level of the buffer, a vertical level at which the moveable unit is adapted to move in its travelling direction and a loading edge of the airport trolley are the same or substantially the same.

Still further, when any minor difference in vertical level of a handled object along its transfer route, such as a decrease of the vertical level of a handled object along the transfer route, such as in the buffer or from the buffer to the loading device, is provided by pieces of equipment positioned at fixed, but slightly decreased vertical levels, when compared to each other, a possible advantage is that a particularly simple but yet effective embodiment of the handling system and the corresponding method is provided.

In general and for both the method and the apparatus aspect of the invention, it may be seen that the invention lies in the insight that particular arrangements of equipment and particular manners, such as handling directions, of handling and loading objects into standard airport trolleys is particularly effective when considering one or more problematics present in a handling area of an airport, where consistency and durability of the systems and methods used is of paramount importance.

By referring to an advantage herein, it must be understood that this advantage may be seen as a possible advantage provided by the invention, but it may also be understood that the invention is particularly, but not exclusively, advantageous for obtaining the described advantage.

In general the various aspects and advantages of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 is a perspective side view of two sorter tracks and a handling system,

FIG. 2 is a top view of FIG. 1,

FIG. 3 is a side view in direction A-A as indicated in FIG. 2,

FIG. 4 is a top view of the handling system and

FIG. 5 is an illustration of an embodiment of the method in accordance with the invention.

### DESCRIPTION OF EMBODIMENTS

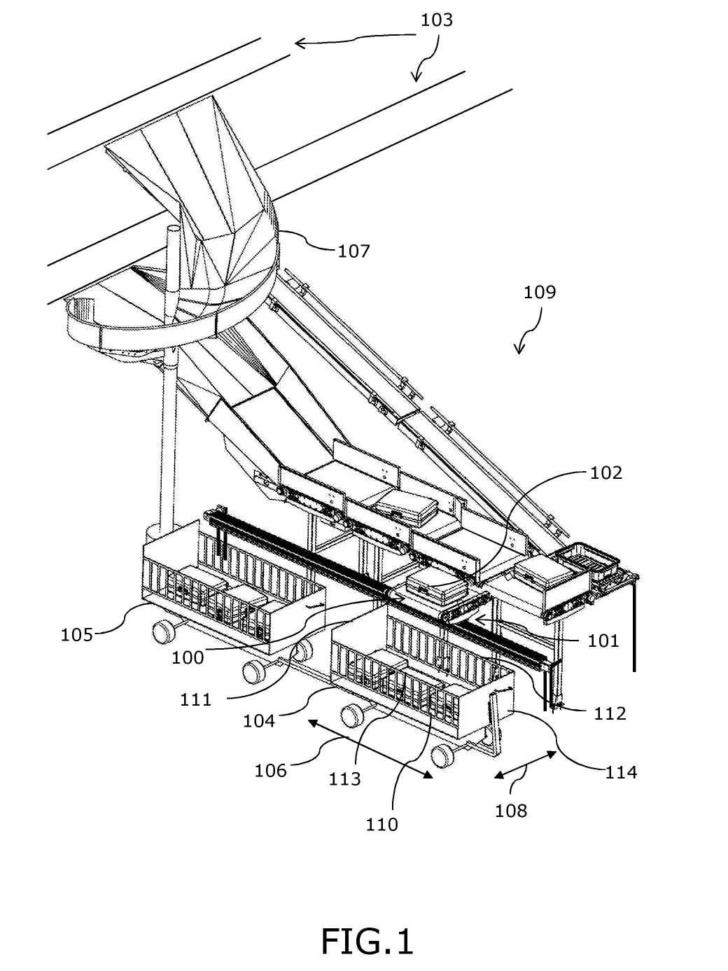

FIG. 1 illustrates a section of a sorter system, which sorter system comprises an embodiment of the handling system 109 according to the invention. The FIG. illustrates a sorter which in the illustration comprises two sorter tracks 103. The sorter may alternatively comprise only one track and can be of any type of sorter such as a tilt-tray sorter, a cross-belt sorter or a conveyor based sorter system. Objects sorted by the sorter or by the sorter conveyor are discharged from the sorter into a chute 107. Normally, a plurality of chutes or exits is present in order to be able to distribute or sort objects to various destinations.

Often, the sorter is capable of sorting more than three to five thousand objects per hour and systems capable of sorting hundred thousand or more objects per hour are also known, but such systems may comprise several separate sorters.

Often, the sorter is an endless loop where one or more objects which have not been discharged during a complete circulation on the loop are just recirculated a number of times, e.g. until their discharge is able to receive the one or more objects or until the object is handled otherwise. Other types of sorters, such as a line sorter will most often end in a conveyor which transports any non-discharged objects back to an in-feed station for induction of the object to the sorter line again.

Such non-discharged objects may be referred to as recirculated objects and recirculation of objects is generally unwanted in that this reduces the capacity of the system and thus lowers the effectiveness of the system.

In case the handling system 109, which receives and handles the objects by use of conveyors etc., after the objects have been discharged, is not able to handle objects discharged from the sorter fast enough, and thus further objects cannot be discharged from the sorter, unwanted recirculation may occur. Numerous ways of preventing recirculation has been described in reference systems.

In FIG. 1 it is illustrated that the handling system 109 is adapted to load objects into or onto one or more airport trolleys. In the illustrated embodiment two airport trolleys are shown, a first airport trolley 104 and a second 105.

It is illustrated that an object 102 is present on a loading device 100. The loading device 100 is arranged so as to load one or more objects at a time into or onto one of the airport trolleys 104 or 105. The loading device is comprised on a moveable unit 101 which is adapted to move along the length 106 of the airport trolley 104.

The airport trolley has a bottom 110, two length sides 112 and 113 and two width sides 114 and 111. It can be seen that the four sides extend upwards from the bottom 110 and surround the bottom. When no objects are present in the airport trolley, the bottom and sides form an empty space without hindrances, which can be filled with objects, to form a bulk of objects in the airport trolley. After being filled and/or when no further objects are to be moved by the trolleys positioned at rest at the loading device 100, the trolleys are moved on their wheels for subsequent unloading of the objects from the trolley into an aeroplane for the destination.

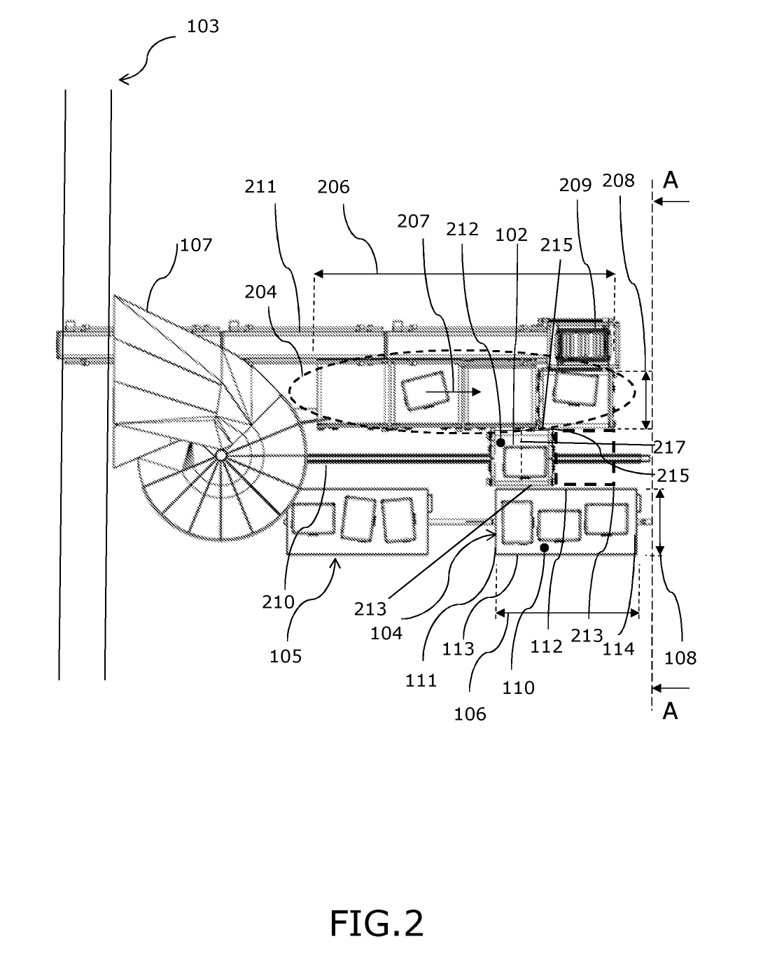

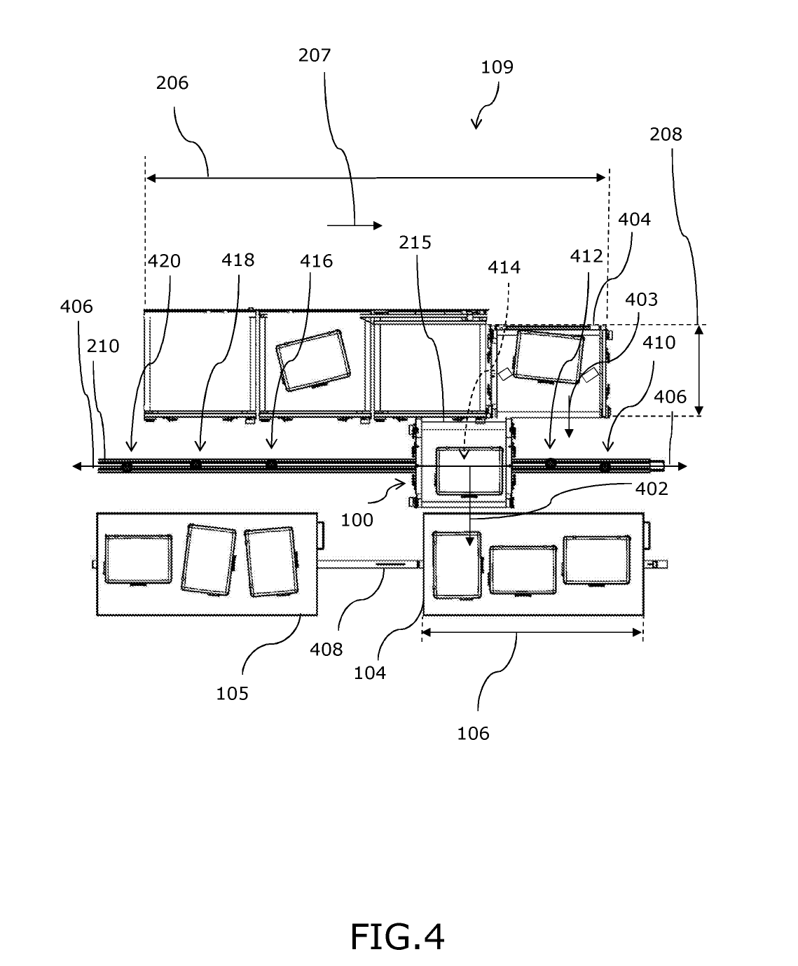

FIG. 2 is a top view of FIG. 1. The figure illustrates a buffer 204. In the illustrated embodiment the buffer comprises four driven conveyor belts on which objects can be buffered and moved in a moving direction 207 as indicated for the object shown at a second belt of the buffer 204. This moving direction 207, from left to right in the shown view and along the length 206 of the buffer, is a primary moving direction of an object in the buffer, until the object has reached and is present on an end most belt, with the reference number 404 in FIG. 4, of the buffer 204. The buffer has a width with the reference number 208.

The illustrated handling system is also capable of handling objects which are placed in a tote 209 when the object is sorted by the sorter and when the tote with such object is discharged into the chute 107 and moved in the buffer 204. Such totes are emptied by a turning station positioned next to and adjoining the end most conveyor of the buffer. The tote is emptied by the turning station and the object falls out of the tote and onto the end most buffer belt, i.e. onto a fourth buffer belt of the illustrated buffer. The emptied tote is carried back for repeated filling by the structure 211.

An object present on the end most buffer belt of the buffer can then be transferred to the loading device by actuating the end most conveyor belt of the buffer and handled further by the loading device. The loading device is illustrated as a driven conveyor belt 212 with the object 102 in the figure.

It follows from the figure that the loading device, i.e. the driven conveyor belt 212, is adapted to be moved along a rail 210. It also follows that a receiving side 215 of the loading device is positioned adjacently next to and adjoining, e.g. the end most conveyor of the buffer 204.

Similarly, it follows from the figure that a loading side 213 of the loading device from which the objects can be loaded into or onto the airport trolley 104 or 105 is aligned with or substantially aligned with the length side 112 of the airport trolley. Furthermore it follows that the loading side is adjoining or substantially adjoining the length side 112 of the airport trolley. A width and a length of the loading device, i.e. in the present embodiment of the conveyor belt 212, is adapted to fit a maximum sized object.

Alternatively or additionally, more than one conveying surface may be provided on the loading device. In this respect, and as an example, two separate belts may be provided and comprised in and moveable with the moveable unit. Such belts may be provided in order to be able to receive part of an object at the receiving side of the loading device, while loading another object into an airport trolley at the loading side of the loading device.

Alternatively or additionally, two belts may be positioned next to each other in the travelling direction of the moveable unit 101. As an example, the belt 212 may be split along the dashed line 217 and each of such belts would then, e.g., be suited for one smaller object. Alternatively or additionally and as illustrated with an additional belt 213, shown with dashed lines in the figure, two, possibly full sized, belts may also be positioned on the moveable unit next to each other in this other direction and such as to move and/or handle two objects by the loading device. Each of such more than one, such as two, separate conveyor belts would preferably be separately driven and controlled.

Alternatively or additionally, two or even more separately moveable loading devices, each comprised on a separate moveable unit 101, may be provided and controlled for individually controlled travelling motion, such as along the rail 210. In such a configuration, one loading device would then e.g. be able to pick up one or more objects at the buffer, such as at the end most belt of the buffer, while another loading device fills one or more pieces of luggage into an airport trolley or is travelling towards an unload position.

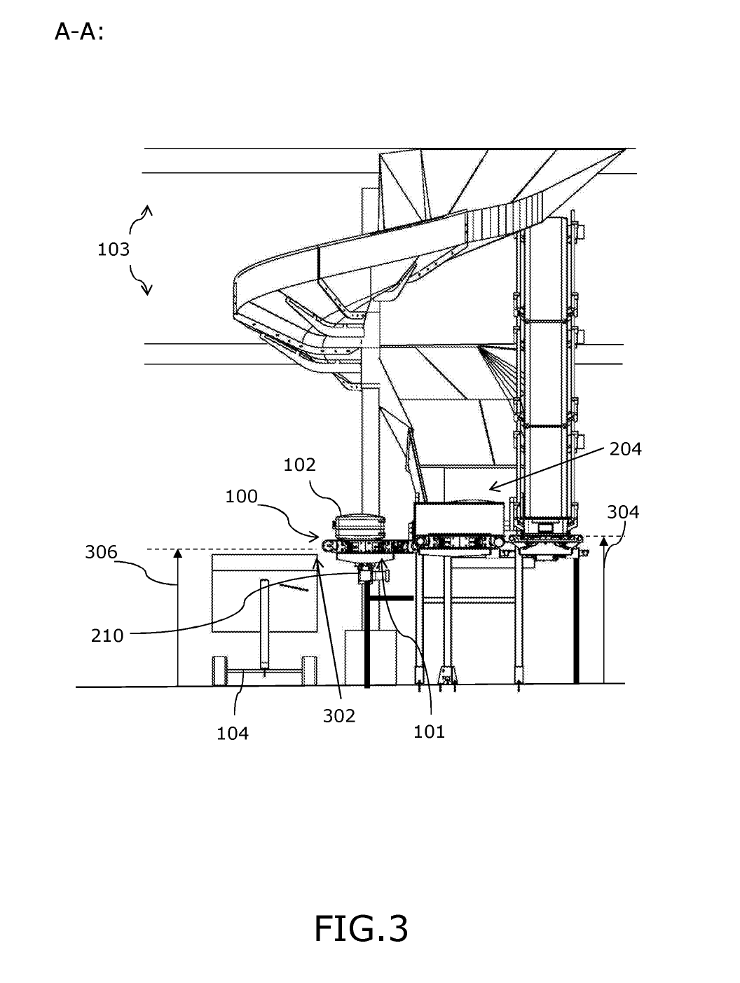

FIG. 3 is a front view in the direction indicated at A-A in FIG. 2. It can be seen that due to the vertical level of the rail 210, the vertical level 306 of the moveable unit 101, will remain at this vertical level 306 when the unit moves along the rail 210. From FIGS. 1, 2, 3 and 4 it follows that this movement is parallel with or substantially parallel with the airport trolley length 106, or moreover parallel with or substantially parallel with a direction in which the airport trolley length 106 is measured.

Further, it is illustrated that buffering the objects and moving the objects in the buffer 204, in the moving direction of objects in the buffer, is provided at one vertical buffer level or substantially at one vertical buffer level 304 of the buffer or moreover of one or more conveying surfaces of the buffer 204.

In the illustrated embodiment the vertical level 306 of the moveable unit 101 is the same or substantially the same as the vertical level 304 of the buffer. Thus in method language: moving the objects along and in the buffer and moving the objects by the moveable unit is provided by moving the objects at a same vertical level or substantially at the same vertical level. In the embodiment shown there is a slight decrease of the level 306 of the moveable unit or moreover of the conveying surface of the loading device, when compared to the level 304 of the buffer.

It has been found that such slightly decreased levels or such same or substantially same levels are particularly effective and even further effective when the vertical level 306 is at or, as shown, just above a loading edge 302 of the length side 112 of the airport trolley. It may be preferred that a vertical level of a conveying surface of the driven belt 212 of the loading device is adapted to be, e.g. 0.02-0.40 meter above an upper edge of the length side 112 of the airport trolley.

With such system and in such manner, any minor difference of vertical level of a handled object along its transfer route, such as the described decrease of the vertical level of a handled object along the transfer route, such as from the buffer 204 to the loading device 100 may, as shown, be provided by pieces of equipment positioned at fixed, but slightly decreased vertical levels 304, 306.

Hereby an effective way of loading objects into the moveable storage can be provided where the corresponding handling system, e.g., requires a minimum of maintenance. Further, when in this manner preparing the objects to be loaded into the standard airport trolley primarily using gravity to provide lowering a vertical level of the objects—less energy is used—which can be found as an alternative indicator for an amount of cost of the required equipment and/or an amount of required maintenance of the equipment and thus effectiveness of the method and system.

In FIG. 4 it is illustrated that preparing for loading the object into or onto the airport trolley 104, 105 may, as illustrated, comprise moving the object on the loading device 100 by using the moveable unit (101, as seen in FIGS. 1 and 2). The moveable unit is adapted to move the loading device 100 linearly in a travelling direction 406 of the moveable unit. In the illustration this linear movement is provided by the moveable unit cooperating with a rail 210, but other ways of providing the movement may be used.

From the figure it also follows that objects to be handled by the loading device 100 can be buffered using the buffer with the buffer length 206 and with the buffer width 208. As illustrated the buffer length is larger than the buffer width and the moving direction 207 of the objects is in the direction of the buffer length and the buffer length direction is parallel with the airport trolley length 106.

The figure also illustrates that the moveable unit 101 carries the loading device 100, i.e. the driven belt conveyor, and that the loading device has a loading direction 402 which is transverse to the airport trolley length 106. Hereby a simple and yet effective loading of one or more objects present on the loading device and into or onto the trolley 104, 105 can be provided by actuating the loading device 100 in the loading direction 402.

Further it follows that an end most conveyor 404 of the buffer 204, i.e. in the shown embodiment the fourth conveyor, has a conveying direction 403 which is parallel with the loading direction 402 of the loading device 100. The handling method and corresponding system and overall handling of the objects is particularly effective when two airport trolleys 104, 105 are at rest and coupled, by a coupling 408, in line and in tandem at fixed relative positions as shown.

Still further, and as an example, a required amount of footprint and a complexity of the method and corresponding system are decreased when one, two (as shown) or more airport trolleys 104, 105 is/are positioned with their length direction parallel with or substantially parallel with the travelling direction 406 of the moveable unit 101.

Along the travelling direction of the moveable unit 101, it may be preferred to set a number of loading positions 410, 412, 414, 416, 418, 420 along the one, two or more airport trolleys 104, 105 from and to which positions the loading device 100 is adapted to move after having received one or more objects from the end most buffer belt 404. The loading position 412 is a position where a middle of the loading device 100 is in a middle or substantially in a middle of the length of the airport trolley. This position is also in a middle or substantially in a middle of the (drum of the) end most buffer belt 404. Thus when the loading device is positioned in the position 412, and not in the position 414 as shown, the loading device can maintain this position while items are loaded into a middle or substantially into the middle of the airport trolley 104.

It can be seen that in the shown embodiment the moveable unit 101 is adapted to move between positions along the length of at least two coupled airport trolleys. The moveable unit may in alternative embodiments only be moveable from and to positions along the length of one single airport trolley, or along the length of three or more airport trolleys.

Thus, in operation, the moveable unit is adapted to carry the loading device, which loading device is adapted to receive one or more objects from the buffer and for unloading one or more received objects into an airport trolley. Further the moveable unit is adapted to move back and forth between one or more positions where objects are received and to one or more loading positions, at which loading positions the one or more received objects are filled into the airport trolley, i.e. loaded into the trolley.

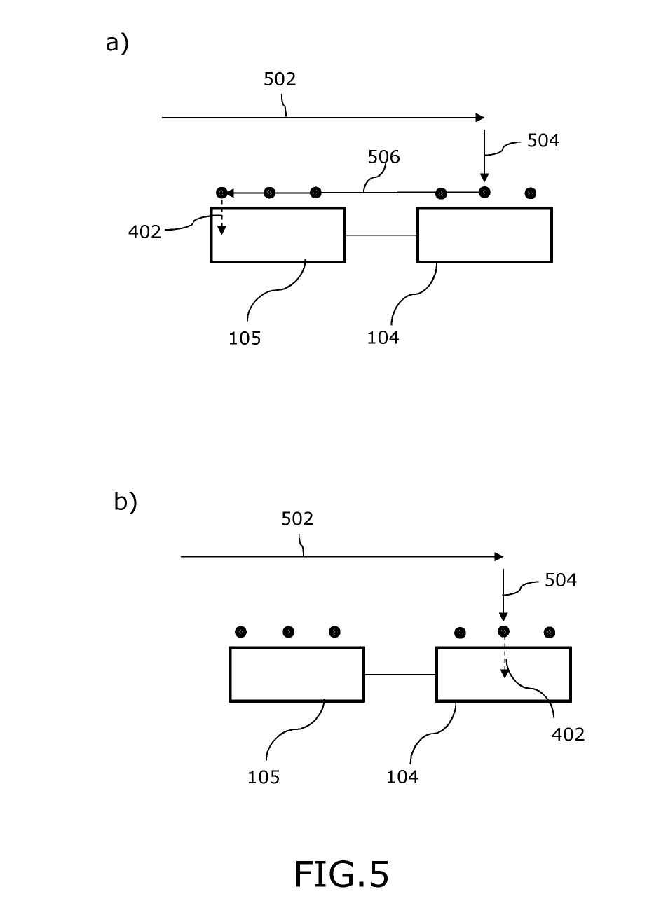

In FIG. 5 it is illustrated that in an embodiment of the method in accordance with the invention, handling the objects comprises discharging an object from a sorting or a conveyor system, and, after discharging the object: moving the object in a first transfer direction 502, such as the moving direction 207 of the object in the buffer 204, as shown in FIG. 2. Further, it is illustrated that after having moved the object in the first transfer direction 502, the moving direction of the object is changed so as hereafter to enable moving the object in a second transfer direction 504, such as the conveying direction 403 of the end most conveyor 404 of the buffer 204, as illustrated in FIG. 4 and transferring the object along the second transfer direction 504 to the loading device and either performing step a) or b) as follows and as illustrated.

Where step a) comprises moving the loading device in a third direction 506, such as in the travelling direction 406 of the moveable unit 101, and subsequently loading the object 102 into or onto the first 104 or the second airport trolley 105 by activating the loading device 100.

Step b) comprises maintaining a position, such as the predetermined position 412 illustrated in FIG. 4, of the loading device 100 and loading the object 102 into or onto the first airport trolley 104 by activating the loading device at this position 412.

Performing step a) or b) may follow in dependence of or in response to a number and/or position of objects in or on the first 104 and/or in the second airport trolley 105 and/or in dependence of a number and/or position of one or more objects prior to the loading device 100.

From FIG. 4 it follows that the position 412 is substantially in a middle of a width direction of the end most conveyor 404 of the buffer 204. When an airport trolley is present, it may be preferred that this position is in the middle or substantially in the middle of the length 106 of the airport trolley. This may, e.g., enable a highest number of objects to be filled into the airport trolley without moving the moveable unit.

Surprisingly, it has been found particularly effective if the method and corresponding system comprises moving an object in the third transfer direction 506 and this direction is opposite to or substantially opposite to the first transfer direction 502.

In short it is herein disclosed that an example of an aim with the disclosed method and system may be seen to provide a method and system which does not require more square meters of footprint than existing solutions or even requires less square meters of footprint, while still being as effective as, or even more effective than reference methods and systems. The handling system comprises a moveable unit 101 adapted to move linearly in a travelling direction 406 of the moveable unit, where the moveable unit comprises a loading device 100 adapted to load one or more objects 102 at a time into or onto the airport trolley 104, 105 by activation of the loading device 100.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims however the inclusion of the reference signs is only for clarity reasons and should not be construed as limiting the scope of the claims.

1. A method of handling a variety of objects of different size, shape and weight in an airport, the method comprising:
determining a destination for an object using scanning equipment,
moving the object in accordance with the destination using conveyors and/or one or more sorters, and
loading the object into or onto a moveable storage device using a loading device, wherein said storage device is to be used for moving a plurality of objects to an aeroplane for the destination, and wherein said moveable storage device is an airport trolley.

2-30. (canceled)

31. The method according to claim 1, wherein said airport trolley has a bottom and a number of sides, which sides extend upwards from the bottom and surround the bottom, which bottom and sides, when no objects are present in the airport trolley, form an empty space without hindrances, which space can be filled with objects, to form a bulk of objects in said airport trolley.

32. The method according to claim 1, further comprising preparing for loading the object into or onto said airport trolley by moving the object parallel with or substantially parallel with an airport trolley length or length direction of said airport trolley.

33. The method according to claim 1, further comprising preparing for loading the object into or onto said airport trolley, prior to loading the object into or onto the airport trolley, by moving the loading device along or substantially along a straight forward or straight backwards rolling direction of the airport trolley.

34. The method according to claim 1, further comprising preparing for loading the object into or onto said airport trolley by moving the object on the loading device using a moveable unit.

35. The method according to claim 34, wherein the moveable unit is adapted to move the loading device linearly in a travelling direction of the moveable unit.

36. The method according to claim 32, wherein moving the object parallel with or substantially parallel with said airport trolley length is carried out at one vertical level of and by a moveable unit.

37. The method according to claim 34, further comprising moving the object parallel with or substantially parallel with said airport trolley length at one vertical level of and by said moveable unit.

38. The method according to claim 1, further comprising buffering one or more objects prior to the objects being handled by said loading device, wherein said buffering is provided using a buffer having a buffer length and a buffer width, wherein said buffer length is larger than said buffer width and a moving direction of said objects in said buffer is in a buffer length direction and said buffer length direction is parallel with or substantially parallel with an airport trolley length of said airport trolley.

39. The method according to claim 38, wherein said buffering comprises the buffered objects being buffered and moved in said moving direction at one vertical buffer level or substantially at one vertical buffer level along and in said buffer.

40. The method according to claim 39, wherein said one vertical level of said moveable unit is the same or substantially the same as said vertical level of said buffer, and moving the objects along and in said buffer and moving the objects by said moveable unit is provided at a same vertical level or substantially at the same vertical level.

41. The method according to claim 40, wherein said same vertical level or said substantially same vertical level is adapted for loading an object into or onto said airport trolley by said loading device from a vertical level at, or just above, a loading edge of said airport trolley.

42. The method according to claim 34, wherein said moveable unit comprises said loading device, and the loading device is adapted to load the object into or onto said airport trolley.

43. The method according to claim 42, wherein the loading device is having a loading direction which is transverse to or substantially transverse to an airport trolley length of said airport trolley, and wherein said method includes actuating the loading device in said loading direction and thereby loading the object into or onto said trolley.

44. The method according to claim 43, wherein an end most conveyor of said buffer has a conveying direction, which is substantially parallel with or parallel with said loading direction of said loading device.

45. The method according to claim 1, wherein loading said object into or onto said airport trolley is provided while said trolley is at rest.

46. The method according to claim 1, further comprising positioning two airport trolleys coupled in line and in tandem in fixed relative position to each other and at rest.

47. The method according to claim 34, further comprising positioning one or two airport trolleys with their length direction parallel with or substantially parallel with the travelling direction of said moveable unit.

48. The method according to claims 34, further comprising moving the moveable unit linearly in said travelling direction to one of a predetermined number of loading positions along one, two or more airport trolleys.

49. The method according to claim 48, further comprising filling said one, two or more trolleys by repeatable loading of one or more objects at a time from said predetermined loading positions by said loading device.

50. The method according to claim 1, wherein the handling of one or more objects comprises:
discharging the objects from a sorting or a conveyor system,
after discharging the objects:
moving the objects in a first transfer direction,
after having moved the objects in the first transfer direction:
changing moving direction of the objects and so as hereafter to enable moving the objects in a second transfer direction,
transferring the objects along the second direction to the loading device and either:
a) moving the loading device in a third direction, and subsequently loading the one or more objects into or onto a first or a second airport trolley by activating the loading device, or
b) maintaining a position of the loading device and loading the one or more objects into or onto a first airport trolley by activating the loading device at said position,
in dependence of a number and/or position of objects in or on said first and/or said second airport trolley and/or in dependence of a number and/or position of one or more objects prior to the loading device, which one or more objects are to be loaded.

51. The method according to claim 50, wherein the second transfer direction is transverse or substantially transverse to the first transfer direction.

52. The method according to claim 50, wherein a moving distance of the loading device in the third transfer direction with one or more objects to be loaded, is increased, when relatively few or no objects are buffered prior to the loading device.

53. The method according to claim 50, wherein the first and third transfer directions are parallel or substantially parallel and/or a vertical level of the moving objects is the same or substantially the same in two or more vertical levels of movement among the first, second and third transfer directions.

54. The method according to claim 53, wherein moving an object in the third transfer direction comprises moving the object in a direction opposite to or substantially opposite to the first transfer direction.

55. A handling system adapted to carry out the method according to claim 1, the handling system comprising:
a moveable unit adapted to move linearly in a travelling direction of said moveable unit, the moveable unit comprising a loading device adapted to load one or more objects at a time into or onto an airport trolley having an airport trolley length, by activation of the loading device.

56. The handling system of claim 55, wherein the moveable unit is adapted to move in the travelling direction at one maintained vertical level.

57. The handling system according to claim 55, further comprising a buffer for buffering one or more objects prior to the loading device, wherein two or more of: a length of the buffer, a travelling direction of the moveable unit and the length of the airport trolley are parallel or substantially parallel.

58. The handling system according to claim 57, wherein two or more of: a vertical level of said buffer, a vertical level at which the moveable unit is adapted to move in its travelling direction and a loading edge of the airport trolley are the same or substantially the same.

59. The handling system according to claim 58, wherein any minor difference of vertical level of a handled object along its transfer route is provided by pieces of equipment positioned at fixed, but slightly decreased vertical levels when compared to each other.
